(19) United States
(12) Patent Application Publication
(10) Pub. No.: US 2008/0180970 A1
(43) Pub. Date: Jul. 31, 2008

(54) LIGHT ASSEMBLIES FOR MOTOR VEHICLES

(75) Inventor: Jens Mertens, Esslingen (DE)

Correspondence Address: REISING, ETHINGTON, BARNES, KISSELLE, P.C., P O BOX 4390, TROY, MI, 48099-4390, US

(73) Assignee: Schefenacker Vision System Germany GmbH, Schwaikheim (DE)

(21) Appl. No.: 12/020,084

(22) Filed: Jan. 25, 2008

(30) Foreign Application Priority Data
Jan. 25, 2007 (DE) 10 2007 005 551.1

(51) Int. Cl. B60Q 1/00

(52) U.S. Cl. 362/548

(57) ABSTRACT

The light has a housing and a light disc, behind which a lighting unit is provided. The lighting unit is divided into at least two separate light-permeable and distanced light windows, having the same or different lighting functions. A partially light impermeable area is provided between them. In order to embody the light such that its divided light windows are perceived as a continuous lighting area, embodied in a simple fashion and produced cost-effectively, at least one additional light impermeable area is provided in the light impermeable area. Thereby, in spite of the divided light window, a continuous light window is discernible for the observer, as required by the legislature, when both light windows fulfill the same lighting function. The light is suitable as a tail light of motor vehicles.

This patent application claims priority to a German filed patent application having application number DE 10 2007 005 551.1, which was filed on Jan. 25, 2007.

The invention relates to a light for vehicles, preferably for motor vehicles according to the preamble of claim 1.

From DE 198 11 570 C2 a light is known, which is embodied as a headlight for vehicles. The light has a housing, a light disc, and a light source. In the center the light disc is provided with a first partial area having optic deflection features. In the exterior edge region between this partial area and the light disc it is embodied at least partially transparent. By this measure a precise contour of the first central partial area is achieved, which is additionally provided with optic blinking features.

The invention is based on the object to embody a generic light such that its divided light windows are perceived as a continuous light area in the lighted state and produced in a simple embodiment and a cost-effective manner.

In a generic light according to the invention this object is attained by the characterizing features of claim 1.

In the light according to the invention the additional light-permeable area is located in the light impermeable area between the two light windows. This achieves that in spite of the divided light window a continuous light window is discernible for the observer, as required by the legislature, when the two light windows fulfill the same lighting function. The additional light-permeable area can be small. It is arranged in the intermediate area between the light windows such that an observer perceives all light windows as a single light window. From a certain distance on the non-luminous intermediate areas blur in the eye of the observer such that the light windows and the additional light-permeable area are no longer recognized as individual light windows.

Such light windows are particularly interesting when design relevant areas of the light shall act as part of the body. Then it is unavoidable to divide it into individual light windows. An alternative thereto is only the enlargement of the light as a whole, because the legally mandated minimum area of the lighting function of the light must be fulfilled. Such large lights are unacceptable, though, for esthetic reasons. Using the light according to the invention the legally mandated minimum areas of the lighting function can be fulfilled without being forced to enlarge the light as a whole.

The light according to the invention is advantageous in that it can be produced very cost-effectively because essentially the same tools are used as for conventional lights.

Additional features of the invention are discernible from the claims, the description, and the drawing.

The invention is explained in greater detail using some embodiments shown in the drawings. They show:

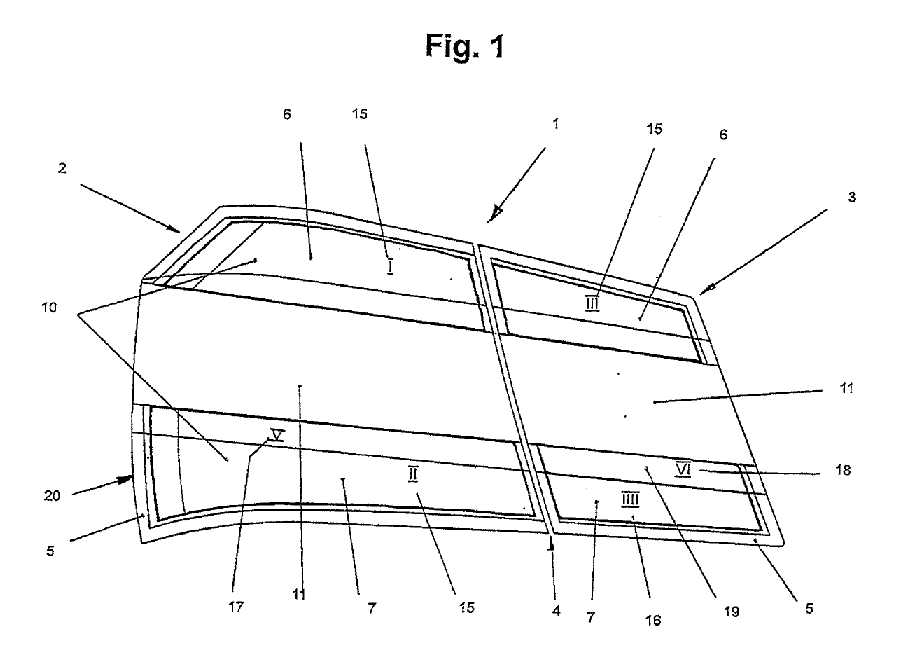

FIG. 1 a light for a lighting function having two separate, distanced light windows,

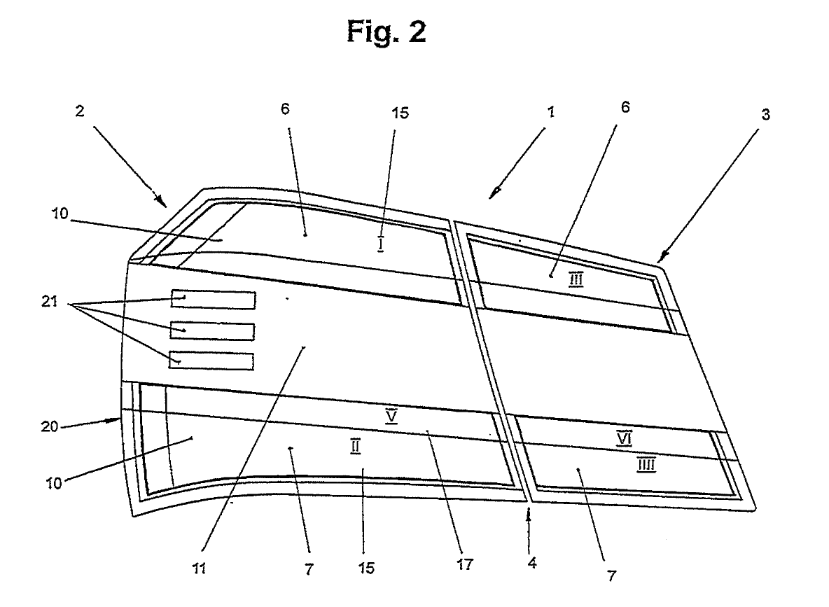

FIG. 2 a light according to the invention having light windows distanced from each other, which are separated by an intermediate area in which a lamellar light-permeable area is provided,

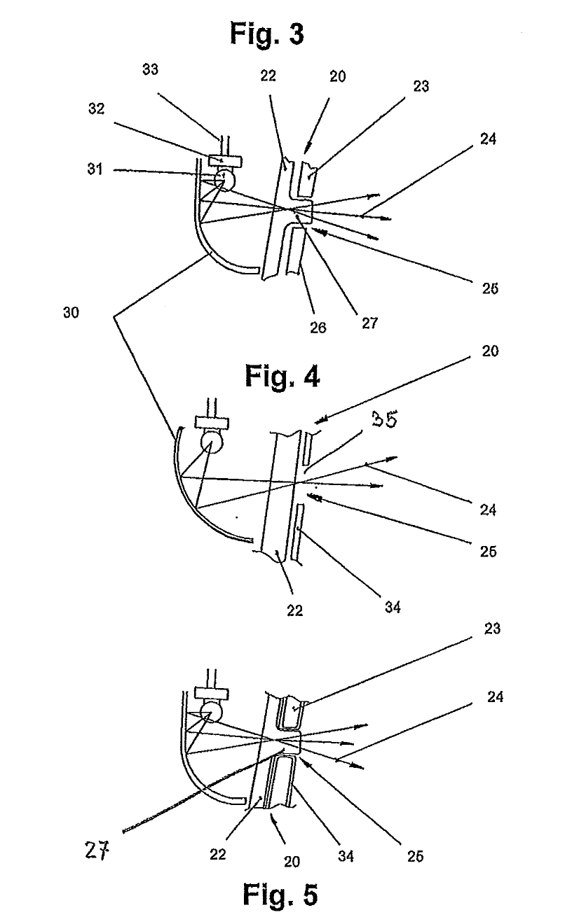

FIG. 3 a cross-section through the light according to FIG. 2 in a schematic representation,

FIG. 4 and FIG. 5 additional embodiments of lights according to the invention each according to the illustrations of FIG. 3.

FIG. 1 shows a light 1 having two separate light windows 6, 7 for a common lighting and/or signaling function. The light 1 is a tail light for motor vehicles, divided into two parts 2 and 3. The separating gap 3 of the light parts 2, 3 is located between the body of the motor vehicle and its rear hatch. The light part 2 is mounted to the body at the fender, while the light part 3 is mounted in and/or at the rear hatch and/or the trunk lid. The light part 2 at the body is for example smaller than the light part 3 at the hatch. Depending on the motor vehicle model the size ratio may also be inverse, or both light parts 2, 3 may have the same size. The light parts 2, 3 can show different perimeters.

Both light parts 2, 3 are each provided with the upper light window 6 and the lower light window 7, respectively separated by a light impermeable and/or light-permeable area 11. Said area is essentially arranged in the middle of the light parts 2, 3. The area 11 represents for example a part of the light disc 20 dyed or enameled in the vehicle color, limiting the light 1 at one side. At least one lighting means 31 (FIGS. 3 through 5) is arranged behind this area 11 such that only in this area 11, similar to a positioning light, a weak, matte light is allowed to appear and/or to shine. In the exemplary embodiment the lighting means 31 is a light bulb, however it may also be a LED or another lighting means. The light bulb sits in a socket 32, which is connected to electric wires 33 for supplying power to the light bulb.

The upper and the lower light windows 6 and 7 of each light parts 2, 3 can be connected to each other within the light 1. A single lighting means 31 is sufficient to light the light windows 6, 7 when its light is reflected via a common reflector 30 to the light windows. The exterior observer then gets the impression that they represent two individual lights.

Of course, separate light areas may also be provided behind the respective light windows 6, 7, which are provided at least with one light means 31 and at least one reflector 30.

The two light windows 6, 7 of the light parts 2, 3 may be allocated to the same lighting functions 15 or different lighting functions 15, 17. For example, the upper light window 6 of the hatch side of the light part 3 may have the same lighting function 15, 17 as the upper and the lower light windows 6, 7 of the body part of the light part 2. The lower light window 7 of the hatch side light part 3 can for example be divided into two or more different lighting functions. The lower half can for example be embodied as a fog light 16 or a back-up light 19. The upper half of this lower light window 7 can for example form a reflector 18. Of course, various combinations and connections of these lighting functions are possible.

As another potential combination, for example the light windows 6, 7 of the body-side light part 2 can be provided with multiple lighting functions, in which for example an existing tail light 15 is combined with a turn signal 17. In a respectively large distance of the upper light window 6 from the lower light windows 7 the impression develops for an external observer that they represent two individual light windows/lights.

As illustrated in FIG. 1, for example the tail light 15 is formed by the two light windows 6, 7 of the body-side light part 2. According to the legal stipulations the tail light 15 of a rear light, in which the tail light 15 is divided into several independent, distanced fields, must amount to a total of 60% of the area of the overall tail light. This regulation does not apply to divided areas 6, 7. Here, the tail light 15 always appears as a continuous, connected area.

In order to fulfill this stipulation in such a divided light, according to FIG. 2, lamellar light-permeable areas 21 are provided in the light impermeable area 11 between the upper and the lower light windows 6, 7 of the body-side light part 2. They are additional small light windows, which show the same lighting function as the upper and/or the lower light windows 6, 7 of the light part 2. An external observer positioned at a sufficient distance from the vehicle experiences the light 1 with its upper and its lower light windows 6, 7 and the area 21 as a continuous light.

Here, it is necessary and mandated by the legislature that the upper edge of the area 21 is arranged at a distance no greater than 15 mm from the lower edge of the upper light window 6. The same stipulation also applies to the lower edge of the area 21, which must be at a distance of no more than 15 mm from the upper edge of the lower light window 7. By this small distance it is ensured that any observer standing at the rear at some distance perceives the observed light 1 as a continuous light window 6, 7, 21. Of course the area 21 can also be embodied as a one-part area. When the area 21, as shown in FIG. 2, comprises several individual lamellar elements 21, the distance between adjacent elements 21 may not be greater than 15 mm. The areas 21 can be located both in the left as well as the right half and in the middle between the upper and the lower light windows 6, 7.

It is not mandatory for the areas 21 to show a rectangular linear shape. Other shapes are also possible, assuming the impression develops that the upper and the lower light windows 6, 7 are connected to each other. For example, the areas 21 may be circular or elliptic or have rounded, triangular, or polygonal shapes.

The areas 21 may have several different lighting functions, similar to the individual light windows 6, 7. For example, in the upper light window area the light window 6 can be embodied as a tail light 15 with a partially separated area representing a turn signal 17, while the lower light window 7 serves exclusively as a tail light 15, for example. In this case, the areas 21 can be operated as turn signals 17 and/or as tail lights 15. The use of such areas 21 is not limited to the body-side light part 2. Of course, the hatch-side light part 3 may also show such areas 21.

Linear areas 21 in the exterior edge regions of the two light parts 2, 3 can be arranged as additional design elements. Here the effect develops that the light 1 appears as a continuous frame.

FIG. 3 shows a cross-section through the light 1 provided with a light disc 20. It comprises two layers 22, 23, which are combined, for example, to form the light disc 20 in a multiple injection molding process. The light impermeable region 11 is provided with a lamellar light-permeable area 25 extending in the longitudinal direction. During the injection molding of one layer 22 the plastic enters the light-permeable area 25, with a respective swelling 27 being formed. Subsequently the exterior layer 23 is sprayed onto the interior layer 22, with its thickness being at least approximately equivalent to the thickness of the swelling 27. In the exemplary embodiment the light impermeable area 11 shows three lamellar light-permeable areas 25 positioned distanced and parallel in reference to each other. Accordingly the interior layer 22 is provided with three swellings 27. After the conclusion of the injection molding process they form the described lamellar, light-permeable areas 21. In the exemplary embodiment the exterior layer 23 comprises a light impermeable and partially transparent, strongly dyed material, which enters into a non-detachable connection with the interior layer 22 in the molding process. The exterior side of the layer 23 and the faces of the swellings 27 form a continuous homogenous plane surface at the finished light disc 20.

Light beams 27 emitted from the lighting means 31 and reflected via the reflector 30 to the rear area of the layer 22 cannot reach the outside through the light disc 20 in the areas, in which the exterior layer 23 is located. At the most, the light beams 24 are reflected back to the reflector 30. The beams 24 are reflected back and forth until they hit one of the swellings 27, which form the light-permeable areas 21. In these areas the light beams 24 pass through the light disc 20 towards the outside (FIG. 3). The interior layer 22 of the light disc 20 is made from a transparent material and/or dyed such that the light beams 24 can pass unhindered to the outside.

Discernible from the exterior such reflectors 18, reflecting structures or other structures, can be applied at the exterior side of the exterior layer 23 of the light disc 20.

In the exemplary embodiment according to FIG. 4 a coating 34 is applied onto the interior layer of the light disc 20. In order to form the light-permeable areas 21 the coating 34 is provided with interruptions 35. Different from the previous embodiment the interior layer 22 is not provided with swellings forming the areas 21. The coating 34 forms the exterior of the light disc 20 and can represent a color coating or a film coating. For the rest, the embodiment according to FIG. 4 can be embodied identical to the one according to FIG. 3.

When the coating 34 comprises a color coating the areas 21 must be masked for the enameling process. In case of a film coating sections can be removed from the film to form the areas 21. These missing parts form the light-permeable areas 21 after the fastening of the film on the layer 22. The light emitted by the lighting means 31 is emitted to the outside via the reflector 18 or directly (as described according to FIG. 3) through the layer 22 and the light-permeable areas 21.

The film 34 can be produced in an easy and cost-effective manner and be applied onto the layer 22. No expensive and costly injection molding process is necessary, as for example in the exemplary embodiment according to FIG. 3.

FIG. 5 shows an exemplary embodiment, implemented identical to the interior layer 22 of the light disc 20 according to the exemplary embodiment according to FIG. 3. The layer 22 has a swelling 27 to form the light-permeable areas 21. The exterior layer 23 is completely covered by the coating 34, which may be a color or film coating, for example.

In a first step the exterior layer 23 of the light disc 20 is produced in a plastic injection molding process. In a second step the layer 23 is covered with the coating 34. Subsequently the coated part is inserted into an injection molding tool, in which the interior layer 22 of the light disc 20 is injection molded with the swelling 27. The interior layer 22 with the swelling 27 advantageously comprises a transparent, dyed transparent material, or one that is different from the exterior layer 23.

In another production process the layer 22 with a swelling 27 is produced in a first injection molding process. The exterior layer 23 provided with the coating 34 is then placed onto the interior layer 22 and connected thereto via an adhesive or welding process. The coating 34 on the layer 22 and/or the layer 23 can be provided with one or several structures. They can be used for a better reflection inside the light 1. The coating 34 on the interior and the exterior layer 22, 23 can be embodied by different materials and/or colors.

1. A light for vehicles, preferably motor vehicles, having a housing and a light disc, with at least one lighting means being provided therebehind and which is divided into at least two light-permeable light windows arranged at a distance from each other, which have the same or different lighting functions and with a least one area being provided between them which is at least partially light impermeable, characterized in that at least one additional light-permeable area (21) is provided in the light impermeable area (11).

2. A light according to claim 1, characterized in that the light-permeable area (21) is embodied in a lamellar fashion.

3. A light according to claim 1, characterized in that the light-permeable area (21) has a round, non-round, or faceted perimeter.

4. A light according to claim 3, characterized in that the distance between the edges of the light windows (6, 7) and the additional light-permeable area (21) is smaller than approximately 15 mm.

5. A light according to claim 4, characterized in that the distance between the edges of at least two distanced light-permeable areas (21) is smaller than approximately 15 mm.

6. A light according to claim 5, characterized in that a common light source (31) is allocated to the light-permeable area (21) and the light windows (6, 7).

7. A light according to claim 5, characterized in that at least one light source (31) is allocated to the light-permeable area (21) and the light windows (6, 7).

8. A light according to claim 7, characterized in that the light-permeable area (21) shines in a color different from the light windows (6, 7).

9. A light according to claim 8, characterized in that a common reflector (30) is allocated to the light windows (6, 7) inside the light (1).

10. A light according to claim 8, characterized in that a reflector (30) is allocated to each light window (6, 7).

11. A light, in particular according to claim 10, characterized in that the light disc (20) comprises at least two layers (22, 23).

12. A light according to claim 11, characterized in that an exterior layer (23) is interrupted in the light-permeable area (21).

13. A light according to claim 12, characterized in that an interior layer (22) of the light disc (20) is provided with at least one swelling (27) engaging the interruption of the exterior layer (23).

14. A light according to claim 13, characterized in that the exterior layer (23) of the light disc (20) is impermeable for light beams (24) of the lighting means (31).

15. A light according to claim 13, characterized in that the exterior layer (23) of the light disc (20) is permeable for light beams (24) of the lighting means (31).

16. A light according to claim 15, characterized in that the exterior layer (23) of the light disc (20) is applied onto the interior layer (22) via a multi-layer injection molding process.

17. A light according to claim 16, characterized in that the swelling (27) of the interior layer (22) comprises a different material and/or a different color than the interior layer (22).

18. A light according to claim 17, characterized in that the exterior layer (23) of the light disc (20) is provided with a covering coating (34).

19. A light according to claim 18, characterized in that the covering (34) is a lacquer coating.

20. A light according to claim 18, characterized in that the covering (34) is a film covering.

21. A light according to claim 20, characterized in that the face of the swelling (27) of the interior layer (22) and the exterior side of the exterior layer (23) of the light disc (20) are positioned essentially flush.

22. A light according to claim 21, characterized in that the swelling (27) of the interior layer (22) is provided with an optic and an optic structure.
